(19) United States
(12) Patent Application Publication
(10) Pub. No.: US 2005/0111199 A1
(43) Pub. Date: May 26, 2005

(54) Slim optical disk drive mounting bracket

(75) Inventor: Terry Harrison, Cedar Park, TX (US)

Correspondence Address: TERRY HARRISON, 11066 PECAN PARK BOULEVARD, D407 #208, CEDAR PARK, TX, 78613, US

(73) Assignee: Harrison, Cedar Park, TX (US)

(21) Appl. No.: 10/906,064

(22) Filed: Feb. 1, 2005

(51) Int. Cl. G06F 1/16

(52) U.S. Cl. 361/724; 361/686; 361/683; 312/223.1

(57) ABSTRACT

The slim optical disk drive-mounting bracket allows anyone to install two slim optical disk drives into a 5.25-inch desktop, tower or rack mount model computer chassis drive bay.
Definition List 1

| Term | Definition |
|---|---|
| Chassis | Pronounced “CHA-see.” Also called case, |
| | a metal frame that serves as the |
| | structural support for electronic |
| | components. Every computer system |
| | requires at least one chassis to house |
| | the circuit boards and wiring. |
| Tower | Refers to a computer chassis in which |
| | the power supply, motherboard, and |
| | mass storage devices are stacked on top |
| | of each other in a cabinet or tower. |
| Rack Mount | Refers to a computer chassis that can be |
| | installed into a rack. |
| Drive Bay | An area of reserved space in a personal |
| | computer where hard or floppy disk |
| | drives (or tape drives) can be installed. |
| | The number of drive bays in a computer |
| | determines the total number of internal |
| | mass storage devices it can handle. |
| Rack | A rack is a standardized system for |
| | mounting various electronic modules in |
| | a “stack”, or rack. The rack consists of |
| | two long, thin metal plates standing |
| | vertically in the same plane with a space |
| | of 18 inches between them. They have |
| | holes drilled through them at regular |
| | intervals, so that the centerlines of the |
| | holes in the two strips are 19 inches |
| | apart. |

A mounting bracket in which two slim optical disk drives can be installed and/or mounted into a 5.25-inch desktop, tower or rack mount model computer chassis drive bay. The mounting bracket consists of two parts.

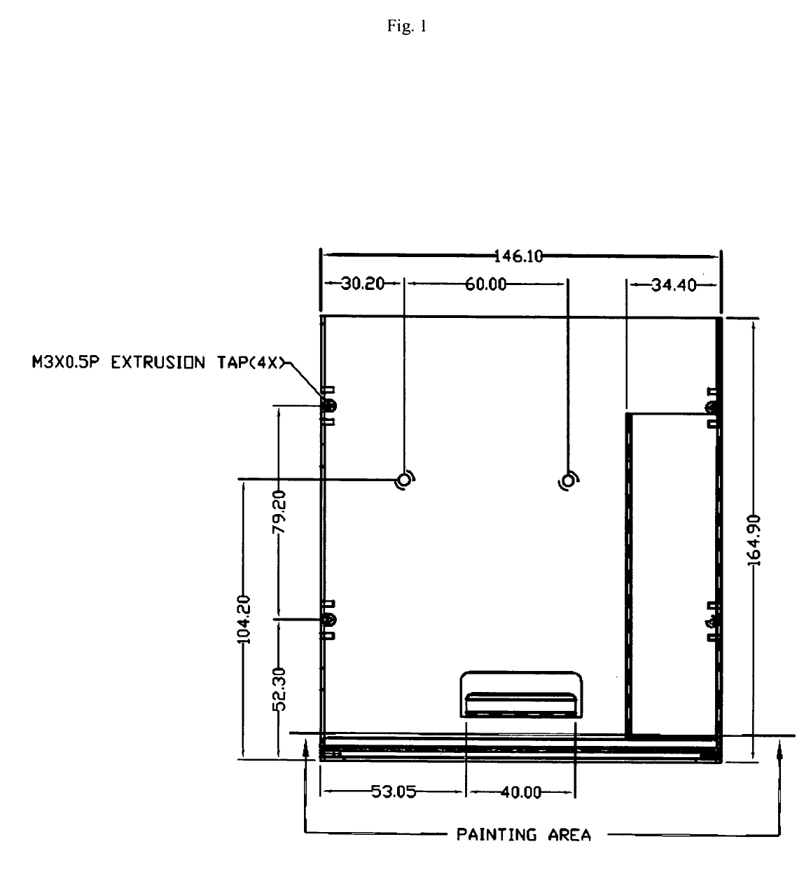

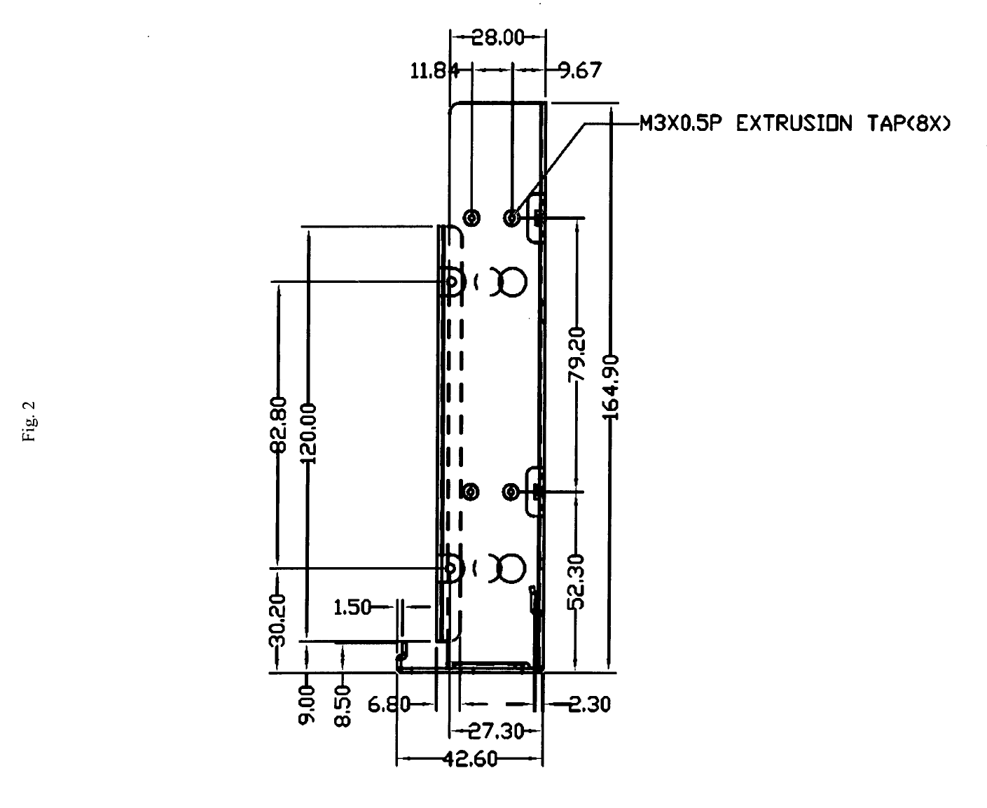

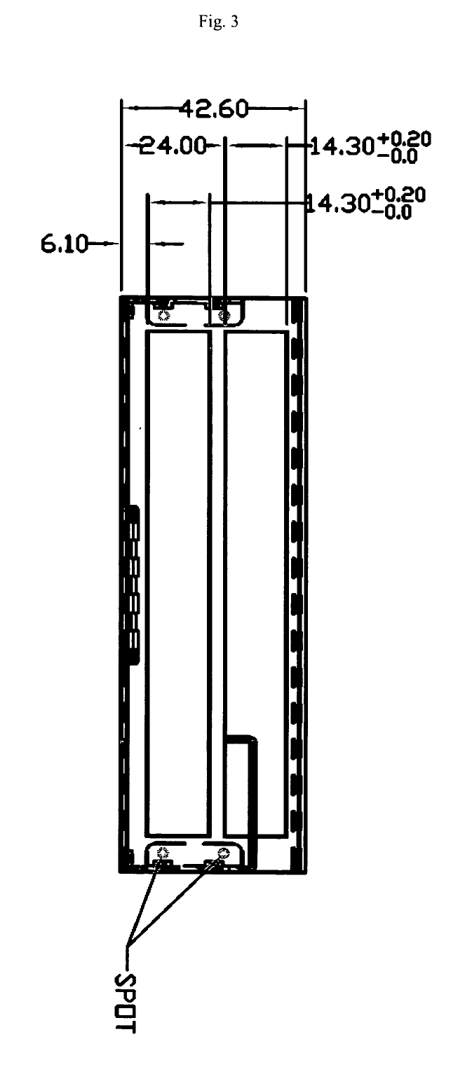

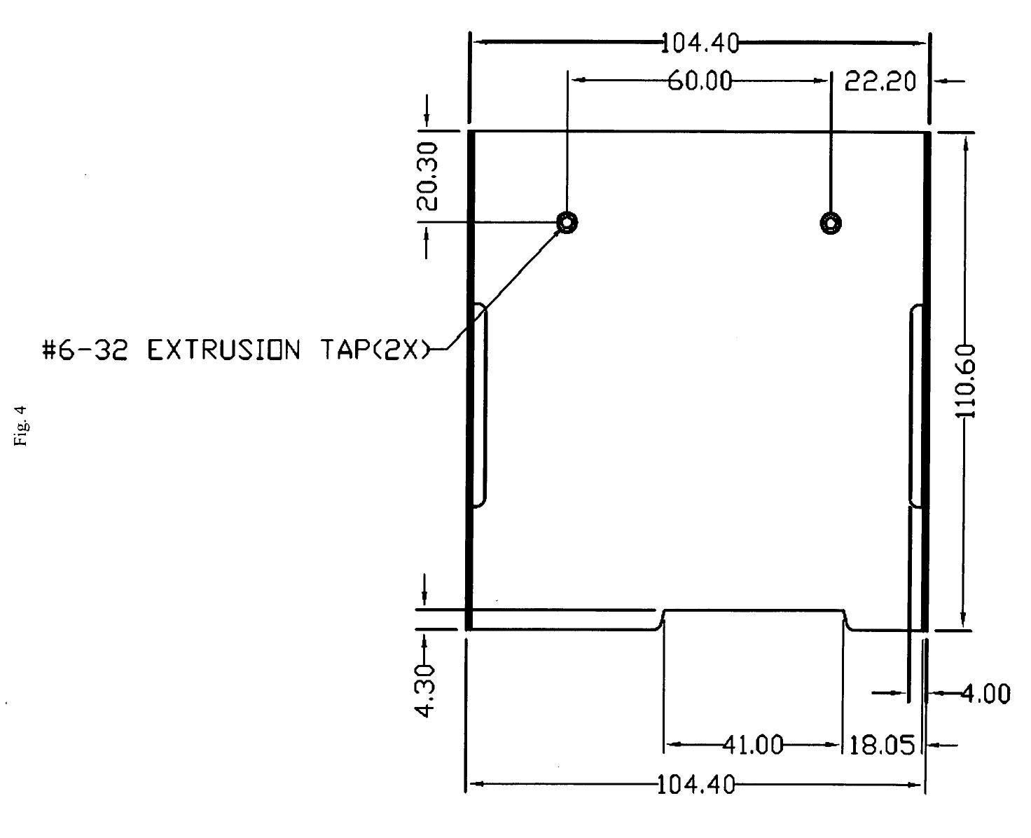

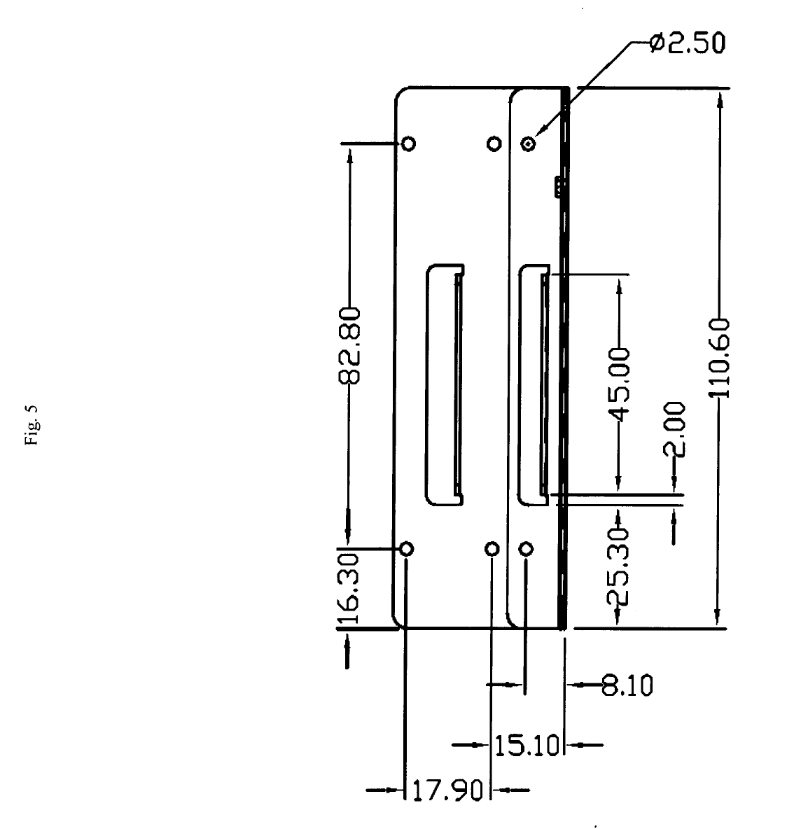

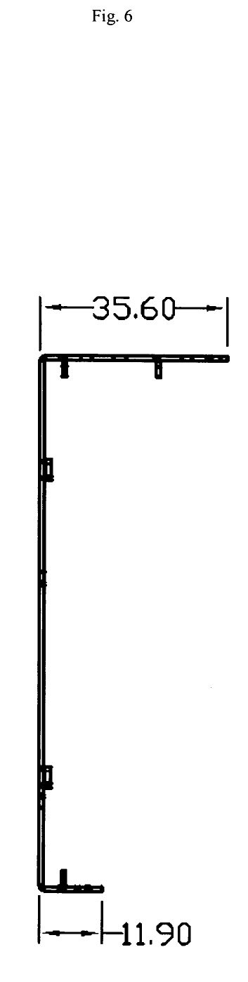

Part #1: Securely holds one of the two slim optical drives in place and connects to part #2. FIG. 1A.
Part #2: Connects to part #1 and securely holds the second slim optical disk drive in place. FIG. 1B.

1. The slim optical disk drive-mounting bracket allows anyone to install two slim optical disk drives into a 5.25-inch desktop, tower or rack mount model computer chassis drive bay.
